(19) United States
(12) Patent Application Publication
(10) Pub. No.: US 2011/0125994 A1
(43) Pub. Date: May 26, 2011

(54) METHODS AND SYSTEMS FOR SECURE ONLINE BROWSING

(75) Inventors: Ari-ben Heard, Alexandria, VA (US); Willie Blount, Columbia, MD (US); Jack C. Hsu, Alexandria, VA (US)

(73) Assignee: TAP Innovations, Inc.

(21) Appl. No.: 12/939,536

(22) Filed: Nov. 4, 2010

Related U.S. Application Data
(60) Provisional application No. 61/258,408, filed on Nov. 5, 2009.

(51) Int. Cl. G06F 9/00

(52) U.S. Cl. 713/2

(57) ABSTRACT

An external operating system (OS) that is separate from the internal OS of a computer is provided. The external OS may be stored on a USB device, a CD ROM, or other devices. The device that stores the external OS may be removable or non-removable, may have an internal flash memory of varying sizes, and may include browser software. The external OS, flash memory size and browser software may be customizable according to user requirements. The computer may boot up from the device into the external OS, rather than into the internal OS of the computer. Once the computer is booted up, the user has the ability to browse online, with all transactions occurring in the external OS, partitioned from the user's internal computer hard drive, thereby preventing infecting the computer by malware or other malicious software.

### CROSS REFERENCE TO RELATED APPLICATION

This application claims priority to Provisional Patent Application No. 61/258,408 filed Nov. 5, 2009, the entirety of which is hereby incorporated by reference.

### BACKGROUND OF THE INVENTION

1. Field of the Invention

Aspects of the present invention are directed to methods and systems for ensuring protection for a computer's internal hard drive and stored data from online threats, browsing habits, virus and malware infection and accumulation, and the transmission of personal data to/from online entities. Specifically, aspects of the present invention are directed to methods and systems that ensure secure online browsing by providing an operating system (OS), which is external to and separate from a computer user's internal OS.

2. Background of the Related Art

One problem that exists in the art today is that online browsing security is difficult to guarantee. When using a computer browser connected to the Internet, a user's computer may be infected via its open communication with the Internet by malware, such as spyware, computer viruses and keystroke loggers, among other types of malicious software, all of which could potentially slow down the user's computer and/or threaten the integrity of the data stored on it. Malware threats may be accrued over time and may remain undetected for years after exposure. The malware is downloaded onto the computer's hard drive, and as long as the hard drive is writable, there is no guaranteed secure way in which to browse and protect data stored on the hard drive.

There is a need in the art, therefore, for methods and systems that ensure secure ways in which to browse the Internet, while protecting data integrity. Furthermore, there is a need in the art for a method and system that ensures that no malware and/or other malicious software will be saved on the computer's hard drive while the user is browsing the Internet. There is a further need in the art for methods and systems that ensure no history will be retained of the sites a user visited while browsing the Internet. There is yet a further need in the art for fast and efficient methods and systems that ensure secure browsing.

### SUMMARY OF THE INVENTION

Aspects of the present invention solve the above-identified needs, and others, by providing methods and systems for ensuring secure ways in which to browse the Internet, while protecting system and data integrity of a computer. Furthermore, aspects of the present invention ensure that no malware and/or other malicious software will be saved on the computer's hard drive while the user is browsing the Internet. In addition, aspects of the present invention ensure that no history of the sites the user visited while browsing the Internet is retained. Further, aspects of the present invention provide methods and systems that ensure fast and efficient secure Internet browsing.

Aspects of the present invention relate to using an external OS, which is separate from the internal OS of the user's computer and is located outside the computer. The external OS may be stored on a Universal Serial Bus (USB) device, a CD ROM, or other devices. The device that stores the external OS may be removable or non-removable, may have an internal flash memory of varying sizes, and may include browser software. In accordance with aspects of the present invention, the external OS, flash memory size and browser software may be customizable according to user requirements. The user's computer (e.g., laptop or desktop) may boot up from the device into the external OS, not the internal OS of the user's computer. In accordance with aspects of the present invention, once the computer is booted up, the user has the ability to browse online, with all transactions occurring in the external OS, partitioned from the user's internal computer hard drive. As a result, any malicious software that has propagated into the external OS will not reach the internal OS of the computer and threaten the integrity of the computer itself and/or the data stored on it.

In one aspect of current invention, the device may be used in read-only mode. This aspect ensures the highest level of security, as no data may be downloaded to the device. This aspect ensures significant protection against malicious software. On the other hand, the read-only mode also limits the ability to download data and software updates.

In another aspect, the device may be used in a read-write mode, which allows the use of the device both in read-only mode and in write mode. When in read-only mode, this aspect ensures the same features as described above with respect to the read-only device. However, a user may manually switch from read-only mode to write mode in order to download data or software upgrades. It should be noted that when the device is in write mode and is connected to the Internet, the device may be compromised by malicious software. However, any malicious software that is downloaded onto the device will remain on the device itself, and will not infect the computer's internal operating system and hard drive.

In yet another aspect, the device may be write-only. This aspect provides the user with an ability to have a clean internal OS and hard drive, separate and apart from the external OS on the device. Malware and other malicious software may, however, be written to the device while the user is connected to the Internet. As with the read-write device described above, however, the malicious software remains on the device and has no effect on the user's internal OS and hard drive.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

FIG. 1 illustrates an exemplary flowchart of the method for secure online browsing, in accordance with aspects of the present invention;

FIG. 2 shows an exemplary flowchart of the method for secure online browsing, in accordance with aspects of the present invention;

FIG. 3 shows an exemplary flowchart of the method for secure online browsing, in accordance with aspects of the present invention;

FIG. 4 presents an exemplary system diagram of various hardware components and other features, for use in accordance with aspects of the present invention; and

FIG. 5 is a block diagram of various exemplary system components, for use in accordance with aspects of the present invention.

### DETAILED DESCRIPTION OF THE INVENTION

Aspects of the present invention will now be described in reference to the accompanying figures. The present invention is not limited to the aspects described herein, however, these and other aspects and variations will be readily apparent to those of ordinary skill in the art upon review of the description that follows.

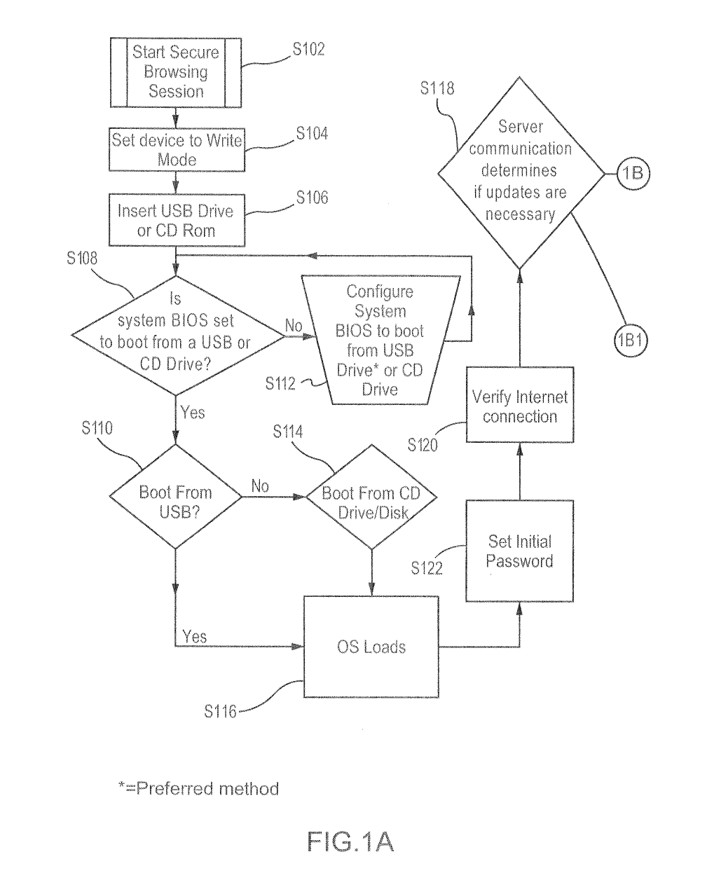

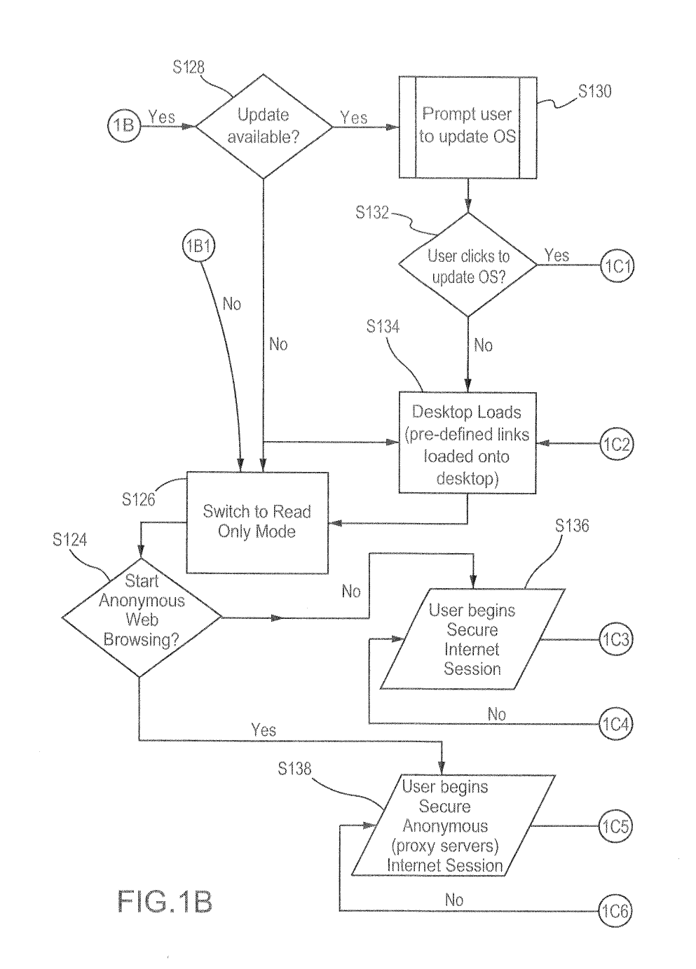

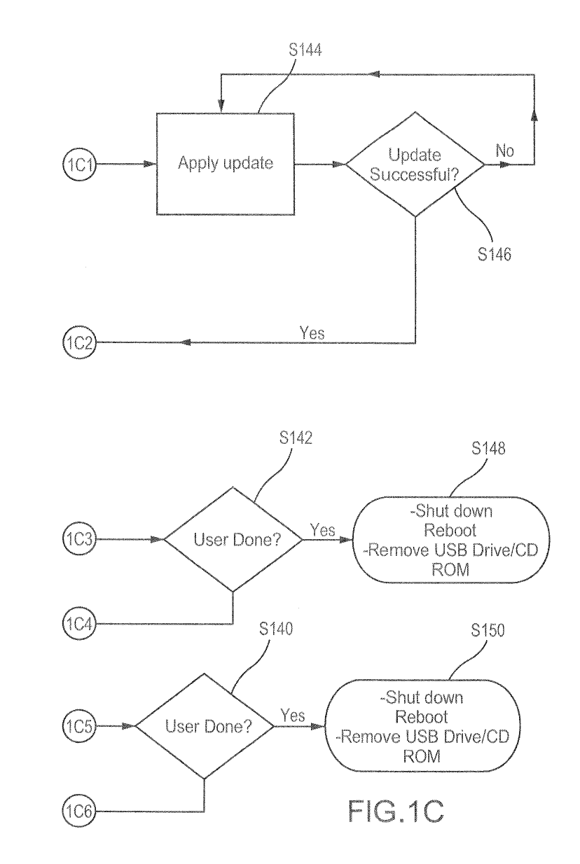

FIG. 1 illustrates an exemplary flowchart of the method for secure online browsing, in accordance with aspects of the present invention. In FIG. 1, according to various aspects of the current invention, the method starts at S102, where a browsing session, which may be secure, is started using a computer. The method continues to S104, where a True Absolute Protection (TAP) tool or device is set to Write Mode. The method continues to S106, where a USB drive or a CD-ROM is functionally coupled to, for example, inserted into, a computer's external drive. The method continues to S108, where a determination is made as to whether the system Basic Input/Out System (BIOS) is set to boot from a USB or CD-ROM drive. According to various aspects of the current invention, if the determination is made that the system BIOS is set to boot from a USB or CD-ROM drive, the method continues to S110, where the system is booted from the USB. If the determination is made that the system BIOS is not set to boot from a USB or CD Rom drive, then the method continues to S112, where the system BIOS is configured to boot from the USB or CD-ROM drive. When the system BIOS is configured to boot from the USB or CD-ROM drive, the method continues to S108 to confirm that the system BIOS is configured as such, and then to S110, where, as discussed above, the computer is booted using the USB. If in S110 the system is not booted from the USB, then the method continues to S114, where the system is booted from the CD-ROM drive. When the system boots either from the USB in S110 or the CD-ROM drive in S114, the method continues to S116, where the OS located on the USB or CD-ROM drive loads onto the computer.

According to various aspects of the current invention, once the OS loads onto the computer, the method continues to S122, where an initial password may be set. Alternatively, no password may be required and S122 may be omitted from the method. The method then continues to S120, where the existence of an Internet connection is verified, and in S118, a determination is made as to whether updates to the external OS are necessary. According to various aspects of the current invention, if updates are necessary, the method continues to S128, where it is determined whether updates are available. If updates are available during S128, then the method continues to S130, where the user is prompted to update the OS. Subsequently, if the user requests an update of the OS, the update is performed in S144. It should be noted that if the external OS is set to read-only mode, the OS would have to be switched to write mode in order to allow the update. Once the update is performed in S144, the method determines whether the update has been successful in S146. If the update has been successful, then the method continues to S134, where predefined links may be loaded onto the desktop of the computer. In S134, when the desktop loads, a set of pre-defined Internet links may be automatically loaded onto the desktop. For example, these links may be links for advertisements that the user of the device may see with a greater frequency than other links when using the Internet. It should be noted that S134 may be omitted, and the method may proceed from S132 directly to S126. If it is determined in S146 that the update was not successful, then the method continues to S144, where the update resumes.

If in S132 the user does not request an update of the OS, then predefined links are loaded onto the desktop of the computer. The method then continues to S126, where the computer is switched to read-only mode. On the other hand, if during S128 updates are not available, the method continues directly to S126, where the computer is switched to read-only mode, where no information can be written on, or downloaded to, the external OS.

According to various aspects of the current invention, when the computer is switched to read-only mode, the method continues to S124, where a determination is made whether anonymous web browsing can start. If anonymous browsing cannot start, the method continues to S136, where the user begins a secure non-anonymous Internet session. On the other hand, if, it is determined that anonymous web browsing can start the method continues to S138, where a secure anonymous Internet session is started.

According to various aspects of the current invention, during the secure Internet session (anonymous S138 or non-anonymous S136), a determination is made as to whether the user has finished using the session in S140 and S142, respectively. If a determination is made that the user has not finished, the session continues. However, if a determination is made that the user has finished with the browsing session, the method continues to S150 and S148, respectively, where the computer is shut down and/or rebooted. At this point, the USB drive or CD-ROM may be removed.

According to various aspects of the current invention, adding the TAP as an external OS to a computer may be performed by modifying the boot manager of the computer OS to add an option, as a separate boot manager, to boot from a boot loader that does not require entry into the BIOS. The separate boot manager may then used be to bypass requirements of BIOS to support booting from a USB, a CD-ROM or other drive. Accordingly, a user may connect the TAP device to the computer and reboot the computer. Upon reboot, a user may have an option of whether to use the computer OS or the external OS. The user may then select which OS should be used.

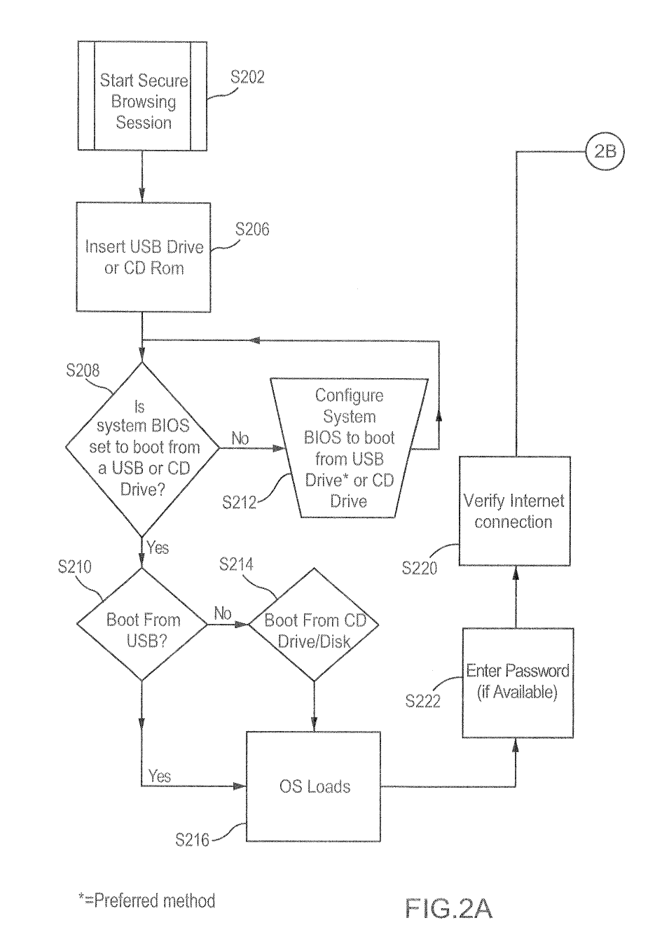

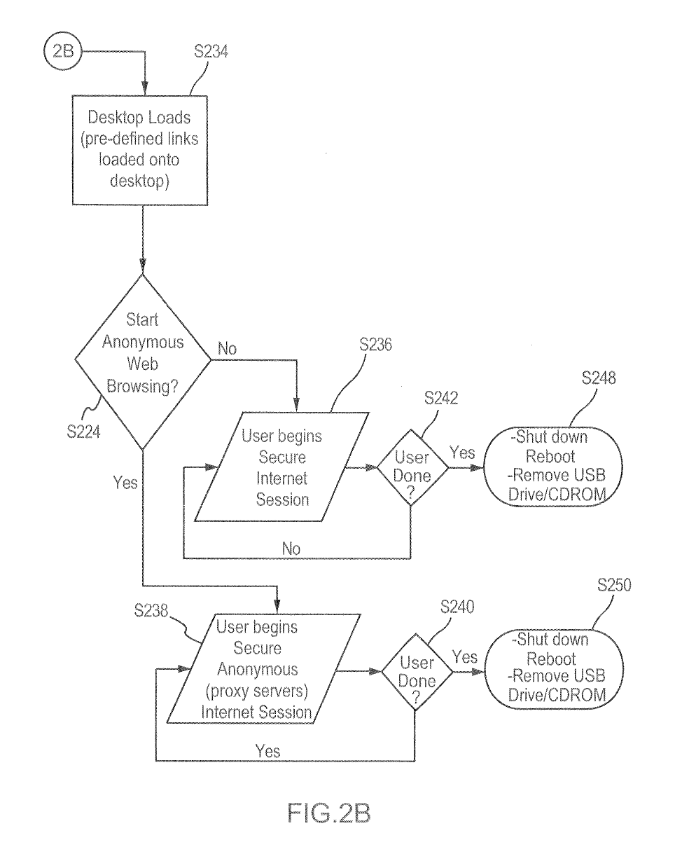

FIG. 2 shows an exemplary flowchart of the method for secure online browsing, in accordance with aspects of the present invention. The method illustrated in FIG. 2 represents an exemplary method that does not include the application of updates to the operation of aspects of the current invention. In FIG. 2, the method starts at S202, where a browsing session, which may be secure, is started using a computer. The method continues to S206, where a USB drive or a CD-ROM drive is functionally coupled to, for example, inserted into an external drive of, the computer. The method continues to S208, where a determination is made as to whether the system BIOS is set to boot from a USB or CD-ROM drive. According to various aspects of the current invention, if the determination is made that the system BIOS is set to boot from a USB or CD-ROM drive, then the method continues to S210, where the system is booted from the USB drive. If the determination is made that the system BIOS is not set to boot from a USB or CD ROM drive, the method continues to S212, where the system BIOS is configured to boot from the USB or CD-ROM drive. When the system BIOS is configured to boot from the USB or CD-ROM drive, the method continues to S208 to confirm that the system BIOS is configured as such, and then to S210, where, as discussed above, the computer is booted using the USB. If in S210 the system is not booted from the USB, then the method continues to S214, where the system is booted from the CD-ROM drive. When the system boots either from the USB in S210 or the CD-ROM drive in S214, the method continues to S216, where the OS loads onto the computer.

According to various aspects of the current invention, once the OS loads onto the computer, the method continues to S222, where an initial password, which may have been set previously, may be entered. Alternatively, no password may be required and S222 may be omitted from the method. The method then continues to S220, where the existence of an Internet connection is verified. According to various aspects of the current invention, the method continues to S234, where predefined links are loaded onto the desktop of the computer. In S234, when the desktop loads, a set of pre-defined Internet links may be automatically loaded onto the desktop. For example, these links may be links to advertisements that the user of the device may see with a greater frequency than other links when using the Internet. It should be noted that S234 may be omitted, and the method may proceed from S220 directly to S224. The method then continues to S224, where a determination is made as to whether anonymous web browsing can start. If anonymous browsing cannot start, the method continues to S236, where the user begins a secure non-anonymous Internet session. On the other hand, if it is determined that anonymous web browsing can start, the method continues to S238, where a secure anonymous Internet session is started.

According to various aspects of the current invention, during the secure Internet session (anonymous S238 or non-anonymous S236), a determination is made as to whether the user has finished using the session in S240 or S242, respectively. If a determination is made that the user is not finished, the session continues. However, if the determination is made that the user has finished with the browsing session, the method continues to S250 or S248, respectively, where the computer may be shut down and/or rebooted. In this case, the USB drive or CR-ROM may be removed.

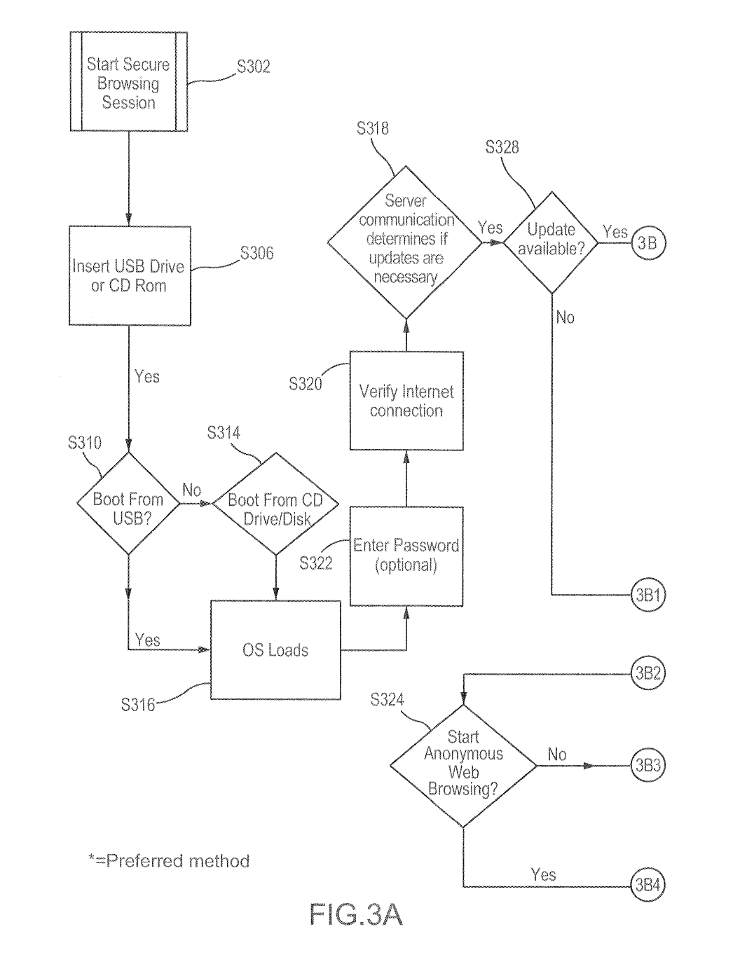

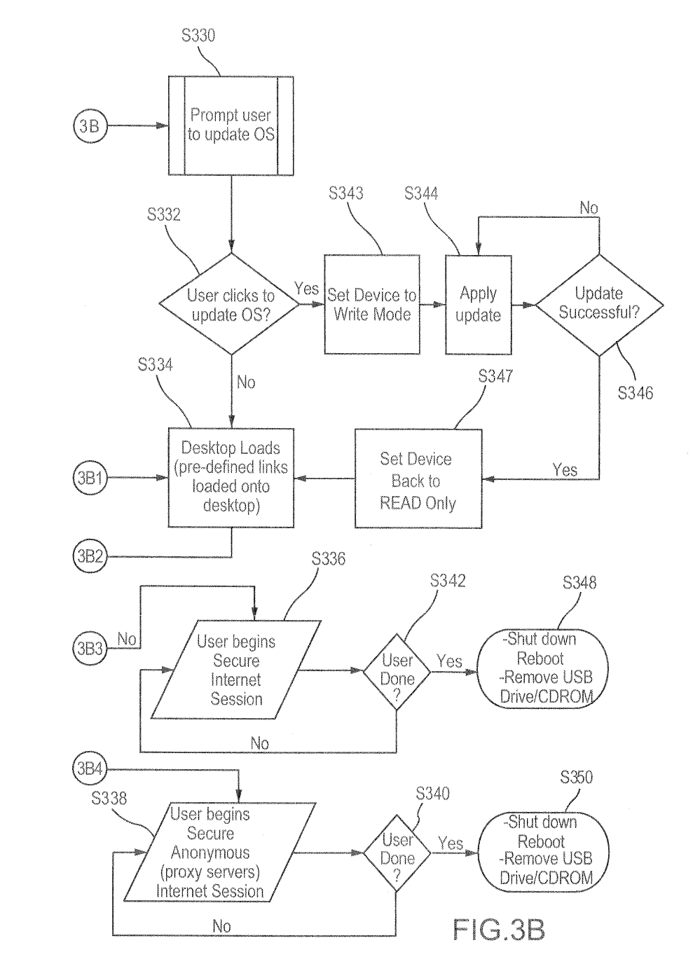

FIG. 3 shows an exemplary flowchart of the method for secure online browsing, in accordance with aspects of the present invention. In FIG. 3, according to various aspects of the current invention, the method starts at S302, where a browsing session, which may be secure, is started using a computer. The method continues to S306, where a USB drive or a CD ROM is inserted in the computer. The method continues to S310, where the system is booted from the USB. If in S310 the system is not booted from the USB, then the method continues to S314, where the system is booted from the CD-ROM drive. When the system boots either from the USB in S310 or the CD-ROM drive in S314, the method continues to S316, where the OS loads onto the computer.

According to various aspects of the current invention, once the OS loads onto the computer, the method continues to S322, where an initial password may be set. Alternatively, no password may be required and S322 may be omitted from the method. The method then continues to S320, where the existence of an Internet connection is verified, and to S318, where a determination is made as to whether updates to the external OS are necessary. According to various aspects of the current invention, if updates to the external OS are necessary, then the method continues to S328, where it is determined whether updates are available. If it is determined that updates to the external OS are available at S328, the method continues to S330, where the user is prompted to update the OS in S332. Subsequently, in S332, if the user requests an update of the OS, the TAP device is set to write mode in S343, and the update is performed in S344. Once the update is performed in S344, the method determines whether the update has been successful in S346. If the update has been successful, the method continues to S347, where the TAP device is set back to read-only mode, thereby precluding any unwanted download of malicious software, and the method continues to S334, where predefined links are loaded onto the desktop of the computer. In S334, when the desktop is initiated a set of pre-defined Internet links may be automatically loaded onto the desktop. For example, these links may be links to advertisements that the user of the device may see with a greater frequency than other links when using the Internet. It should be noted that S334 may be omitted, and the method may proceed from S328 directly to S324. If it is determined in S346 that the update was not successful, the method continues to S344, where the update is reinitiated.

On the other hand, if in S332 the user request an update of the OS, predefined links are loaded onto the desktop of the computer in S334. It should be noted that if during S328 updates are not available, the method continues directly to S334, where predefined links are loaded onto the desktop of the computer.

According to various aspects of the current invention, the method continues to S324, where a determination is made as to whether anonymous web browsing can start. If anonymous browsing cannot start, the method continues to S336, where the user begins a secure non-anonymous Internet session. On the other hand, if during S324, it is determined that anonymous web browsing can start, then the method continues to S338, where a secure anonymous Internet session is started.

According to various aspects of the current invention, during the secure Internet session (anonymous in S338 or non-anonymous in S336), a determination is made as to whether the user has finished using the session in S340 and S342, respectively. If a determination is made that the user has not finished, the session continues. However, if the determination is made that the user has finished with the browsing session, the method continues to S350 and S348, respectively, where the computer is shut down and/or rebooted. At this point, the USB drive or CR-ROM may be removed.

According to various aspects of the current invention, the external OS may be provided in a driver, in which a read-write portion is partitioned from a read-only portion. Accordingly, while updates are downloaded via the read-write portion, the read-only portion of the OS is not affected. Accordingly, the read-only portion cannot be attacked by malicious malware or other malicious software, and any updates or changes to the external OS can be stored in the read-write portion and saved throughout several reboots of the computer. In order to achieve the partition, the primary system image may be compressed as a read-only file system, and a read-write file system may be added to the compressed image. As a result, a user may make edits to the root file system, and may save the edits to the portion of the drive that is read-write. According to various aspects, security may also be provided to restrict access to the read-write portion of the drive in order to protect this portion from malicious attacks.

According to various aspects of the current invention, the external OS can be reset to its initial state, prior to insertion in an external drive of the computer, and at any time during utilization of the external OS. The user may have control of any data downloaded onto the external OS or external drive, to customize the data, and remove the data from the computer without compromising the security of the computer. A remote function may also provide the user with the ability to clear all or part of the browser history and information remotely, without actually reviewing or consulting the browser settings. The drive, whether USB, CD-ROM or other, can contain a security-enabled OS that is partitioned off from a shared, encryptable data drive that is viewable both within the external OS and within any commercial OS. A user using the computer and the computer's standard commercial OS may configure the external OS to prevent its detection. Also, when using the computer via the external OS, according to various aspects, the hard drive of the computer may be hidden from view of a user using the external OS. Accordingly, no changes to, or attacks on, the computer hard drive may be performed when the external OS is used. During use of the computer via the external OS, the network ports of the computer may be closed in order to prevent attacks by malicious software.

According to various aspects of the current invention, the external OS may be configured to send text messages to a portable device such as a cellular telephone or a personal digital assistant (PDA). Updates to the external OS may be scheduled and preformed remotely when the external OS is connected to the computer where the display screen corresponding to the external OS may be viewed from a remote device such as a cellular telephone or a PDA, and the external OS may be remotely allowed or denied access to the Internet or to specific portions, or sites, of the Internet. In cases where remote access to the external OS requires permission, a user located remotely from the external OS may request permission to view the content of the display screen of the external OS via a cellular phone or a PDA. According to various aspects, the external OS may have built-in connections to alternative Internet servers and may be configured to exhibit security features in order to, for example, impose a user time limit for access to specific features of the external OS, to monitor user activity via key logging, for example, to allow an employer or parent to monitor employees' or children's activities on the computer, to maintain an activity log of the external OS, and to communicate in a two-way fashion with a cellular telephone or a PDA. According to various aspects, Internet-based backup may be provided to save a user's personal profile or other data online, the data being data used or generated using the external OS, in order to provide a back-up in case of failure of the external OS.

As discussed above, adding the TAP as an external OS to a computer provides a user with a choice of which OS to use, the computer OS or the external OS. The user may select which OS should be used. An advantage of this method is the ability to provide one or more users with the ability to use the same computer, each user having their own external OS with their own dedicated screen, and separate OS and data storage.

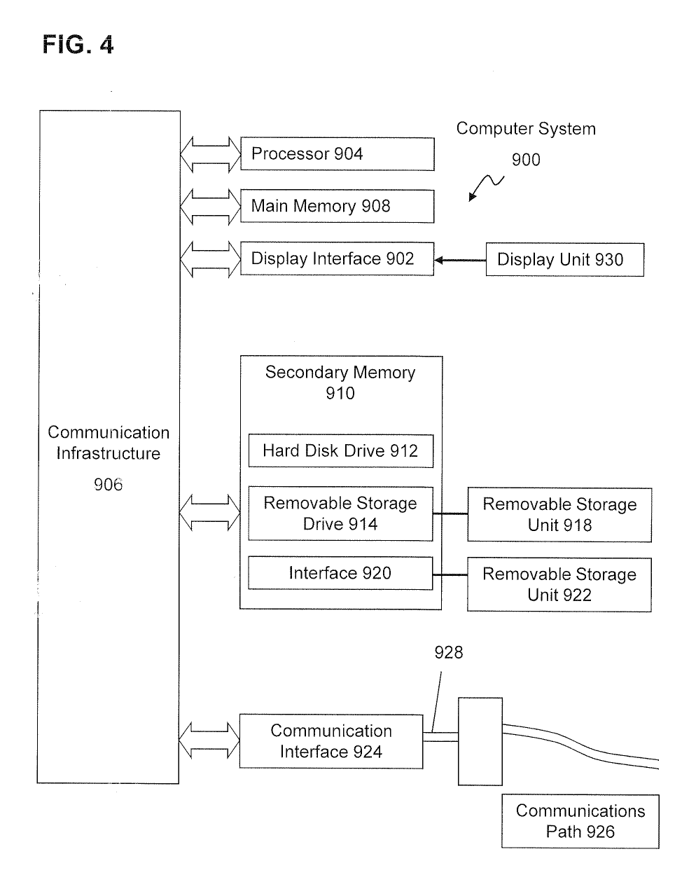

The present invention may be implemented using a combination of hardware, software and firmware in a computer system. In an aspect of the present invention, the invention is directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. Removable storage unit 418, represents a floppy disk, magnetic tape, optical disk, etc., which is read by and written to removable storage drive 414. As will be appreciated, the removable storage unit 418 includes a computer usable storage medium having stored therein computer software and/or data.

Alternative aspects of the present invention may include secondary memory 410 and may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 410 to perform the features of the present invention. Accordingly, such computer programs represent controllers of the computer system 400.

In an aspect of the present invention where the invention is implemented using software, the software may be stored in a computer program product and loaded into computer system 400 using removable storage drive 414, hard drive 412, or communications interface 420. The control logic (software), when executed by the processor 404, causes the processor 404 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

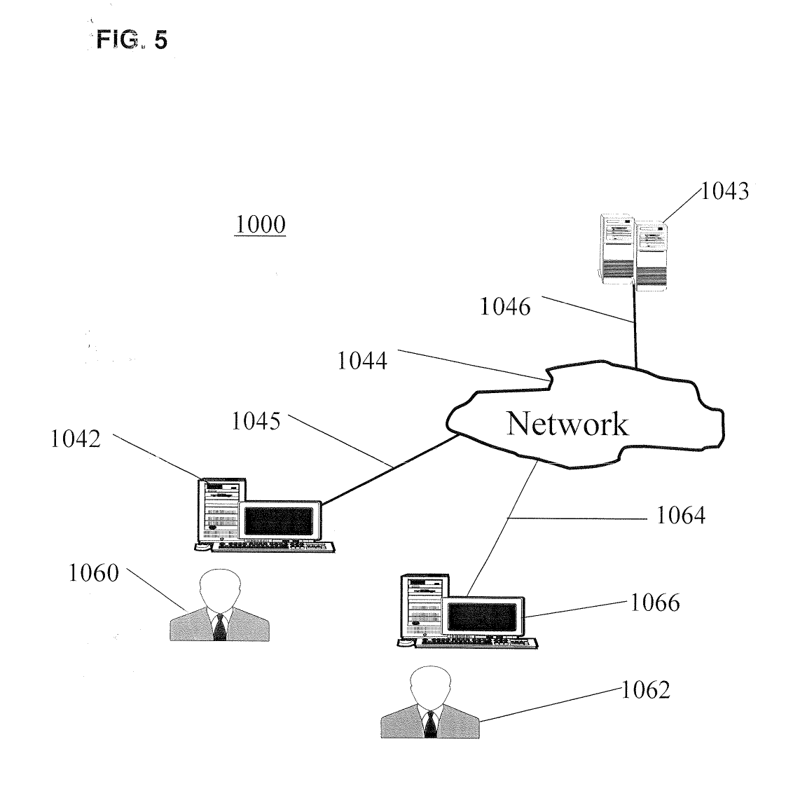

FIG. 5 shows a communication system 500 usable in accordance with the present invention. The communication system 500 includes one or more accessors 560, 562 (also referred to interchangeably herein as one or more “users”) and one or more terminals 542, 566. In one aspect, data for use in accordance with the present invention is, for example, input and/or accessed by accessors 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 564, 546. The couplings 545, 546, 564 include, for example, wired, wireless, or fiber-optic links. In another aspect, the method and system of the present invention operate in a stand-alone environment, such as on a single terminal.

While the present invention has been described in connection with illustrative aspects, it will be understood by those skilled in the art that variations and modifications of the aspects described above may be made without departing from the scope of the invention. Other variations will be apparent to those skilled in the art from a consideration of the specification or from a practice of the invention disclosed herein.

What is claimed:

1. A computer-assisted method for secure online browsing, the computer comprising a processor and a memory, the method comprising:
providing an operating system on a device that is separate from the computer memory;
functionally coupling the separate device to the computer;
booting the computer from the separate device; and
starting a network browsing session;
wherein the network browsing session is operated by the operating system provided in the separate device.

2. The method of claim 1, wherein the network comprises the Internet.

3. The method of claim 1, wherein the separate device comprises a removable device.

4. The method of claim 1, wherein the separate device comprises one of a USB device and a CD-ROM.

5. The method of claim 1, wherein the separate device is set to write-only mode prior to being functionally coupled to the computer.

6. The method of claim 1, wherein the computer system BIOS is configured to boot from the separate device prior to booting the computer from the separate device.

7. The method of claim 1, wherein the operating system provided in the separate device loads when the network browsing session is started.

8. The method of claim 7, wherein an available update to the operating system is determined during loading of the operating system.

9. The method of claim 1, wherein the separate device comprises one of a flash memory, a browser software and an operating system.

10. A secure online browsing system, comprising:
a computer configured to connect to a network;
a separate device configured to be coupled to the computer; and
an operating system stored on the separate device.

11. The secure online browsing system of claim 10, wherein the separate comprises a removable device.

12. The secure online browsing system of claim 10, wherein the separate device comprises at least one of a variable size flash memory and a browser software.

13. A system for secure online browsing via a terminal that has a memory, the system comprising:
a module for providing an operating system on a device that is separate from the terminal memory;
a module for functionally coupling the separate device to the terminal;
a module for booting the terminal from the separate device; and
a module for starting a network browsing session;
wherein the network browsing session is operated by the operating system provided in the separate device.

14. The system of claim 13, wherein the terminal is selected from a group consisting of a personal computer, a minicomputer, a main frame computer, a microcomputer, a hand held device, and a telephonic device.

15. A computer program product comprising a non-transitory computer usable medium having control logic stored therein for causing a computer to provide secure online browsing, the computer comprising a memory, the control logic comprising:
computer readable program code means for providing an operating system on a device that is separate from the computer memory;
computer readable program code means for functionally coupling the separate device to the computer;
computer readable program code means for booting the computer from the separate device; and
computer readable program code means for starting a network browsing session;
wherein the network browsing session is operated by the operating system provided in the separate device.

16. The system of claim 10, wherein the separate device comprises one of a flash memory, a browser software and an operating system.
